(19) United States
(12) Patent Application Publication
(10) Pub. No.: US 2004/0239705 A1
(43) Pub. Date: Dec. 2, 2004

(54) Ink jet printing apparatus and printing method using ink jet

(76) Inventor: Reiji Arikita, Wakayama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/491,750

(22) PCT Filed: Oct. 2, 2002
(86) PCT No.: PCT/JP02/10318

(30) Foreign Application Priority Data
Oct. 5, 2001 (JP) 2001-310098

(51) Int. Cl. B41J 29/38

(52) U.S. Cl. 347/5

(57) ABSTRACT

A print object spread on a print bed is photographed with imaging means, image data taken by the imaging means is compared to image data of a part of specified image data inputted in advance in a memory of a controller which corresponds to reference point to calculate the positional deviation between the fabric spread on the bed and the specified pattern data stored in the memory, the specified pattern data stored in the memory is corrected with an image synthesis section on the basis of the calculation, and a printer head is driven on the basis of a print pattern agreed with the image data taken by the imaging means.

### Technical Field

The present invention relates to printing of design or form patterns onto parts of unsewn sweaters and cut-and-sewn and fabrics (hereinafter, simply referred to as print objects) placed on a printer bed by reading the print objects with imaging means and correcting reference image data stored in the printer to its displacement.

### BACKGROUND ART

Inkjet printing techniques are widely used not only in the field of paper and films but also in the field of dyeing of print objects and, particularly, they are also used to print woven and knitted fabrics in place of conventional printing techniques used for textile.

When the print object is subjected to inkjet printing, the print object is placed on a printer bed by artisan's hands, a printer head is driven by the output section of a controller, and the print object is printed in a predetermined print pattern. When the print object is placed on the printer bed, it is often placed and fixed to a position deviated from a normal position, in which case the print object is replaced from the beginning or only a largely deviated part is partially corrected and then printed.

Knitted-fabric print objects such as sweaters are generally in expanded condition when finished as compared with the products (commodities). Knitted fabrics are large when finished, so that some of them are subjected to the spray of processing agent during preprocessing, thus becoming smaller than knitted fabric when getting wet.

A processing agent for reducing ink bleeding and permeation is sometimes given to perform heat treatment as preprocessing, during which the print object is given a tension (particularly along the length of the print object), so that the print object tends to expand in the tensile direction and to be contraction-deformed in the tensile direction and the vertical direction.

When the processing agent is applied to the print object during preprocessing, the own weight of the print object increases, so that a tension may be applied to expand or contract, deforming the print object.

Furthermore, when an excess processing agent applied to the print object is removed or a pressure is applied from a pressure roller used for causing the processing agent to uniformly permeate the print object, a tension is applied to expand or contract the print object.

However, not only replacing of the print object on the printer bed from the beginning but also partial correcting of only large deviation require much time and labor, thus posing the problem of decreasing print efficiency.

Printed objects are subjected to post-processing including color-developing, cleaning, drying, finishing, etc. after inkjet printing.

Since the printed objects contracts by the post-processing, printed designs also contracts to be deformed by an amount corresponding to the contraction of the print objects. Consequently, when printed with a print pattern stored in the controller, the designs are distorted, thus having the problem of not giving a specified shape and size.

The present invention has been proposed to solve the above problems. Accordingly, it provides an inkjet printer and an inkjet printing method for printing such that finished products are given an optimum design size even if spreading on the printer bed has deviation or print objects expand or contract.

### DISCLOSURE OF INVENTION

In order to achieve the above objects, an inkjet printer according to the present invention is characterized by including a bed for mounting a print object in a spread state on the mount surface, a printer head movable in the X-axis direction and the Y-axis direction on the upper surface of the bed, imaging means moving with the printer head, and a controller for controlling the drive of the printer head. The controller includes a memory for storing at least image data taken by the imaging means and specified reference-pattern data, an arithmetic processing section for calculating the deviation relative to the corresponding part of the reference-pattern data in the memory from the image data taken by the imaging means, and an output section for controlling the printer head on the basis of a print pattern produced from the calculation of the arithmetic processing section.

The invention is also characterized in that the imaging means detects at least two or more points of the origin of the print object placed on the mount surface of the print bed and a reference point apart from the origin and is constructed of a camera for photographing the outline and shape of the print object placed on the mount surface of the print bed.

The inkjet printer according to the invention is characterized by including a bed for mounting a print object in a spread state on the mount surface, a printer head movable in the X-axis direction and the Y-axis direction on the upper surface of the bed, imaging means moving with the printer head, and a controller for controlling the drive of the printer head. The controller includes a memory for storing at least image data taken by the imaging means and specified reference-pattern data, and a retouch section producing a print pattern by designating a specific portion of at least one of the image data picked by the imaging means and displayed on a display and reference-pattern data stored in the memory, adopting a single or combination of print conditions: a change in discharge amount of ink depending on the material and gage, a change in height of the printer head depending on the entire or partial thickness of the knitted fabric and the roughness of the knitted fabric due to the knitted texture, replacement of the printer head for changing the kind of ink depending on the material and the roughness, and shading-off of the boundary.

An inkjet printing method according to the invention is characterized by including: photographing at least two or more points of a print object spread on the mount surface of a print bed with imaging means; comparing image data of the point taken by the imaging means to image data of a point of specified reference-pattern data inputted in advance in a memory of a controller which corresponds to the point to calculate the positional deviation between the print object spread on the bed and the specified reference-pattern data stored in the memory, correcting the specified reference-pattern data stored in the memory on the basis of the calculation to produce print-pattern data by an image synthesis section, and driving a printer head on the basis of the print-pattern data.

### BRIEF DESCRIPTION OF THE DRAWINGS

FIG. 1 is a schematic perspective view of an inkjet printer according to the present invention.

FIG. 2 is a plan view of the inkjet printer according to the invention.

FIG. 3 is a side view of the inkjet printer according to the invention.

FIG. 4 is a block diagram of a controller of the inkjet printer according to the invention.

FIG. 5 is a structural diagram of the interior of a memory of the inkjet printer according to the invention.

FIG. 6 is a diagram of a pattern set in the memory of the inkjet printer according to the invention.

FIG. 7 is a plan view of a print object placed on the mount surface of the inkjet printer according to the invention.

FIG. 8 is a plane view of a print object placed, using a formwork, on the mount surface of the inkjet printer according to the invention.

### BEST MODE FOR CARRYING OUT THE INVENTION

An embodiment of the invention will be described hereinafter with reference to the drawings.

### First Embodiment

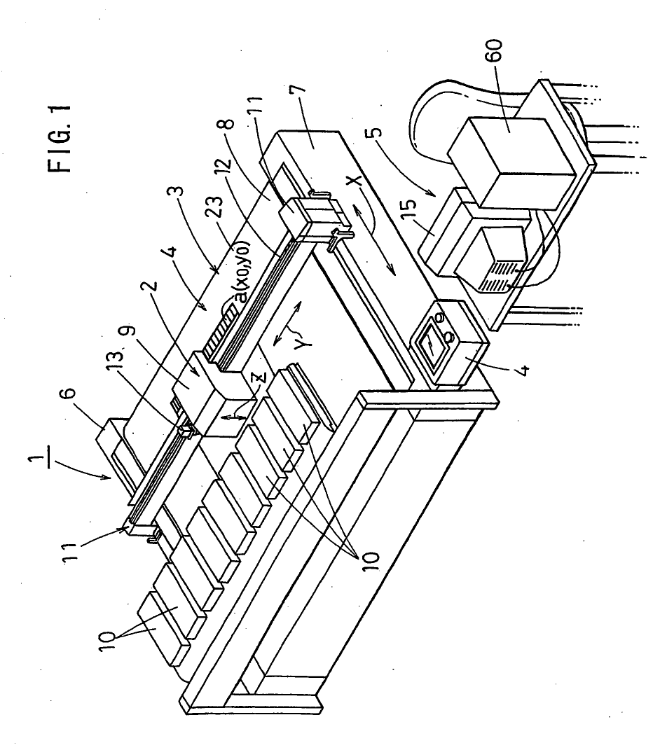

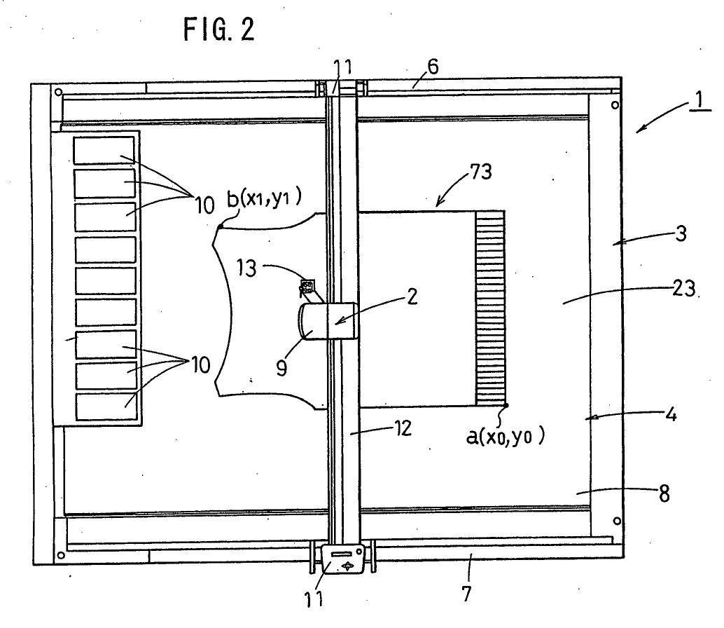

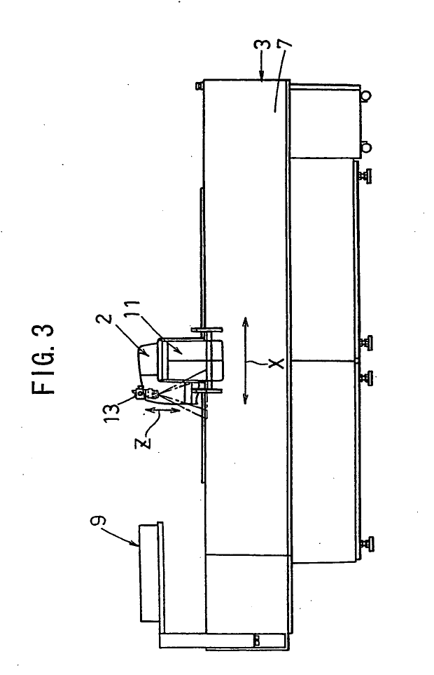

FIG. 1 is a general perspective view of an inkjet printer; FIG. 2 is a plan view of the inkjet printer; and FIG. 3 is a side view of the inkjet printer, in which reference numeral 1 denotes the entire inkjet printer.

The inkjet printer 1 includes a print bed 3 having a printing device 2 and a controller 5 for totally controlling the drive of the printing device 2 and a print-object mount surface 4 of the print bed 3.

The front and rear ends of the print bed 3 are supported by left and right frames 6 and 7 and includes an endless sheet 8 whose upper surface serving as the print-object mount surface 4 and a printer head 9 that can be freely moved in any directions on the print-object mount surface 4. A plurality of print ink tanks 10 is disposed at one side of the frames 6 and 7. The print ink tanks 10 and the printer head 9 are joined together with a supplying tube (not shown).

The printer head 9 includes X-axis-direction moving sections 11 along the length (in the X-axis direction) of the left and right frames 6 and 7 such that they can be moved in the X-axis direction. A beam 12 is placed in the Y-axis direction between the X-axis-direction moving sections 11 and 11. The beam 12 includes the printing device 2 which has a print nozzle mounted to a carriage (Y-axis-direction driving section) (both are not shown) which moves along the beam 12.

The print nozzle can be moved vertically (in the Z-axis direction) with the carriage, from which a jet of ink is discharged by the driving of an ink feed controller; thus printing is performed.

The printer head 9 includes an imaging means 13, on one side, constructed of a CCD camera moving with the printer head 9. The imaging means 13 may be an image pickup tube in place of the CCD camera.

The print bed 3 includes the controller 5 on the side, for totally controlling the inkjet printer 1.

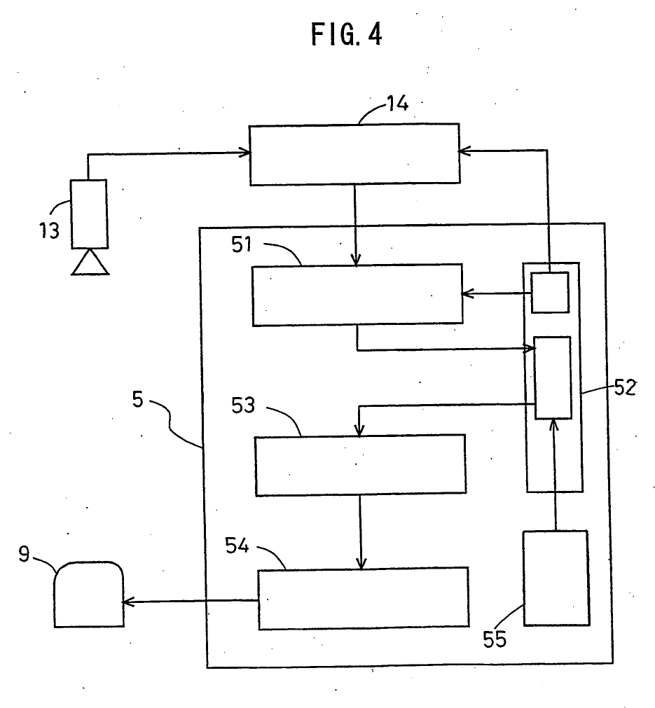

FIG. 4 is a block diagram of the controller 5, an image processor 14, and their periphery. Image data taken by the camera 13 is inputted to the image processor 14. The image processor 14 processes the inputted image data by image recognition processing to recognize the image of point marks such as an origin and a reference point, which will be described later, and outputs the positional information on the recognized point marks to the controller 5.

In the controller 5, an arithmetic processing section 51 compares the inputted point-mark positional information to corresponding point-mark positional information contained in a print pattern that is stored in a memory means 52 to calculate the deviation and corrects reference image data associated with the corresponding point mark on the basis of the given deviation.

In this way, the corresponding data of the reference-pattern data stored in the memory means 52 is corrected on the basis of the positional information of the point mark which is recognized in sequence. Thus the entire reference-pattern data stored in the memory means 52 is corrected and further retouched by a retouch section 55 as necessary.

The processed pattern data is separately written and stored in the memory means 52 as print data.

After the entire reference pattern data stored in the memory means 52 has been corrected in this way, an output section 53 outputs control data based on the corrected print-pattern data read from the memory means 52 to a drive controller 54, thus driving the printer head 9 to perform printing.

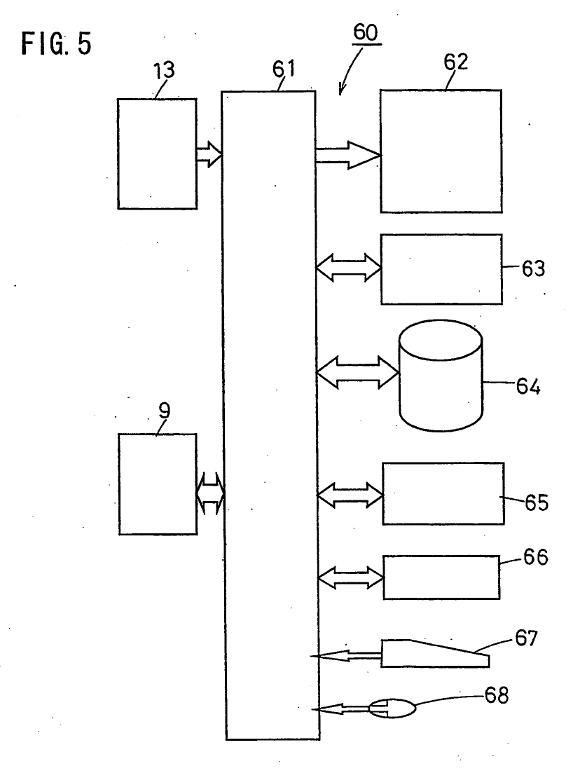

As shown in FIG. 5, the controller 5 and the image processor 14 have a dedicated interface board in the casing and are achieved by a computer 60 in which dedicated printer control software and image-processing software are installed.

The computer 60 has various functions such as a CPU 61, a display 62 such as a CRT, a memory 63 including an ROM that holds a control program etc. and an RAM in which reference-pattern data (shape and so on) is set in advance, a hard disk 64, a removable memory media drive 65, a communication unit 66, a keyboard 67, and a mouse 68.

The software written to the hard disk 64 and the CPU 61 achieve the function corresponding to the image processor 14 and the function corresponding to the arithmetic processing section 51 and the output section 53, shown in FIG. 4.

The memory 63 and the hard disk 64 serve as the function corresponding to the memory means 52, shown in FIG. 4.

The retouch section 55 is operated when there is a need to set printing conditions in detail when correcting reference-pattern data set in the RAM of the memory 63 to produce print-pattern data: specifically, for example, since knitted fabrics such as sweaters have less dimensional stability than cloth, a specific position is specially corrected by comparing an image taken by the imaging means 13 to the reference-pattern data stored in the RAM, the height of the printer head 9 is varied to the roughness due to the knitted structure, the printer head 9 is replaced to a change in material due to the change of knitting yarn, such as an intersia pattern, the discharge amount of ink is controlled, and the boundary in fine gage knitted fabrics is shade off.

The method for inputting to the retouch section 55 is as follows: an image taken by the imaging means 13 is displayed on the display 62 constructed of a CRT, for the displayed image or a composite image of the image taken by the imaging means 13 and the reference-pattern data set in the RAM, its area is designated by input means such as a pen or a tablet, such as designation of the course and the orientation of wale, designation of patterned part, and addition of new design. Specifically, a specific part of the print object is designated, for which print conditions are adopted singly or in combination, such as the discharge amount of ink depending on the material and the gage, a change in height of the printer head 9 to the entire or partial thickness of the knitted fabric and the roughness due to the knitted structure, replacement of the printer head because of a change in the kind of ink to the material or the roughness, and the shading-off of the boundary.

To designate the course or the orientation of the wale to form a design or a pattern such as stripes, masking with a tape has been given, which has been necessary, to prevent unnecessary printing. Such complicated work becomes unnecessary and also intricate stripes can be formed.

A case will be described in which, for example, a logo mark “SHIMA” 34 is printed at the breast of a sweater (print object) 73 or the like on the print bed 3 by the inkjet printer 1 with the above structure.

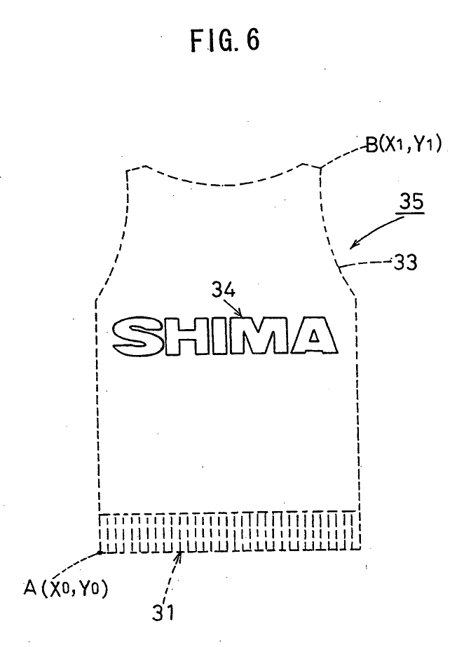

Referring to FIG. 6, the reference logo mark 34 for printing on a sweater 33, with the corner of a ribbed bottom 31 set as origin A (X0, Y0) and the corner of an armhole 32 on the diagonal thereof is set as reference point B (X1, Y1), in the RAM of the memory 63 as pattern data 35.

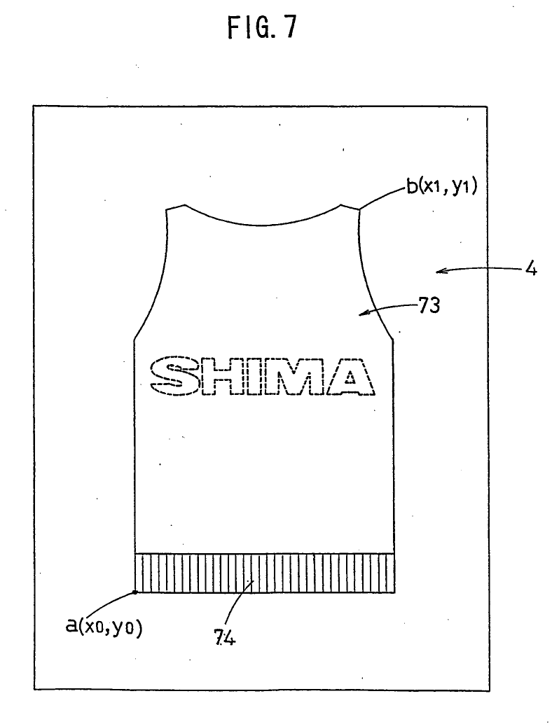

A sweater 73 is spread on the print-object mount surface 4 of the print bed 3 by artisan's hands. When the sweater 73 is spread on the print-object mount surface 4, as shown in FIGS. 1 to 3 and FIG. 7, the corner of a ribbed bottom 74 of the sweater 73 as origin a and the corner of an armhole 75 as reference point b, shown in FIG. 7, are recognized as image data by a camera, and their coordinates a=(x0, y0) and b=(x1, y1) are read from the image processor 14 to the arithmetic processing section 51.

The read origin a and reference point b are compared with corresponding point-mark positional information contained in the pattern data stored in the RAM of the memory means 52 to calculate a deviation by the arithmetic processing section 51. In accordance with the given deviation, the reference logo mark 34 associated with the corresponding point mark is corrected. More specifically, the arithmetic processing section 51 calculates the deviation between the origin A set in the RAM of the memory 16 and the reference point B. In advance of that, the origin A in the reference-pattern data, set in the RAM of the memory 16, and the origin a at the corner of the ribbed bottom 74 of the sweater 73 are agreed with each other.

To agree the origin A in the RAM with the origin a of the print object 73, the numeric value of the coordinates (x0, y0) of the origin a of the print object 73 is substituted for the coordinates (Xa, Ya) of the origin A to set the coordinates of the origin A in the RAM at (x0, y0). Then, the deviation between reference point B′ (Xb′, Yb′) and the coordinates (x1, y1) of the print-object reference point b is calculated.

Thus, the deviation between the reference points B and b in the X-axis direction is expressed as (Xb−x1)=ΔX1, while the deviation in the Y-axis direction is given by (Yb−y1)=ΔT1, wherein when ΔX1=ΔY1 holds, it is determined that the expansion ratios of the width and the length are equal, when ΔX1<ΔY1 holds, it is determined that the print object expands in the width direction and, when ΔX1>ΔY1 hold, it is determined that it expands in the longitudinal direction.

From the result and the angle of the reference point b relative to the origin a of the sweater 73, calculated by (Yb−ya)/(Xb−xa) and so on, the reference-pattern data in the RAM is corrected, and it is stored in the RAM as print-pattern base.

When the print pattern base is stored in the RAM of the memory 63, the reference-pattern data is further corrected by the retouch section 55 by the above-described method and under the conditions as necessary to produce the logo mark 34 that is a print pattern and it is thereafter outputted from the output section 53 to the drive controller 54, where the printer head 9 is driven, thereby printing the logo mark 34, “SHIMA.”

The sweater 74 printed in this way is subjected to post-processing into a finished product (commodity), the desired logo mark 34 “SHIMA” without distortion and deviation, conforming to the specifications is given.

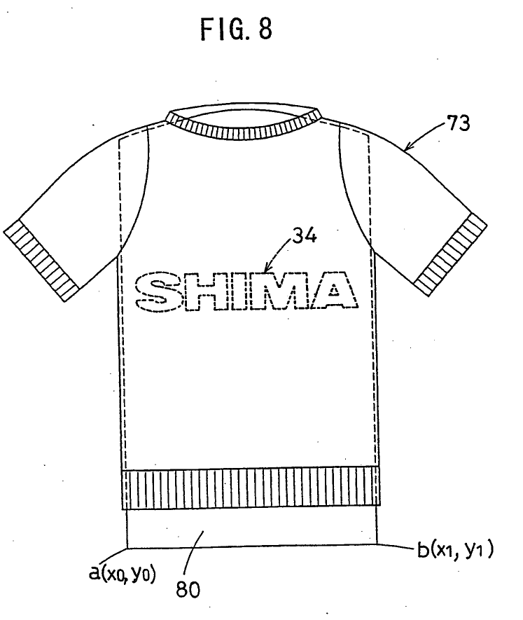

In the above embodiment, although the sweater 73 is directly spread on the print-object mount surface 4 of the print bed 3, it is not limited to that. When the sweater 74 is placed on a form work 80, as shown in FIG. 8, one corner of the lower end of the form work 80 is recognized as origin a, and the other corner is recognized as a reference point b, with which the inclination of the logo mark 34 to be printed is adjusted. Storing the shape, size, etc. of the product 74 which processed with the form work 80 in part of the form work 80 in the form of IDs, barcodes, etc. allows immediate application to various types.

The method of detecting the points such as the origin and the reference point, as in this embodiment, allows the imaging means to be constructed of a mark sensor in place of the camera and, of course, allows application not only to the logo mark 34, as described above, but also to design and pattern printing.

### Second Embodiment

This embodiment photographs the image of the outline of the print object 73, such as a sweater and parts, placed on the print-object mount surface 4 of the print bed 3 with the imaging means 13 moving with the printer head 9 to recognize the shape (size and inclination) of the print object 23, using the similar system to that of the first embodiment.

Recognition of the form includes a method of recognizing the end of the print object 73 by scanning the line in accordance with the reference print pattern and data in the RAM and a method of moving a camera along the shape of the reference print pattern predetermined in the RAM to recognize the shape (size and inclination) of the outline of the print object 73.

Thus, the reference-pattern data such as the size and the inclination of the parts predetermined in the RAM of the memory 63 is corrected based on the recognized shape, almost in the same way as the first embodiment, and is further corrected by the retouch section 55 as necessary, as in the first embodiment, a print pattern is determined.

It is outputted from the output section 53 to the drive controller 54 and the ink feed controller of the printer head 9 to drive the printer head 9, thereby starting printing, as in the first embodiment. When the form work 80 is used for the print object 73 on the print-object mount surface 4 and the IDs and the barcodes of the data of the products that use the form work 80 are stored therein, the inclination and the distortion of the sweater 73 on the print bed can be detected quickly and reliably and, when the data is stored in the form work 80 with magnetism or barcodes, which are read by respective readers and, when at least part of the form work is made of metal, the size of the form work, the distortion of the product and so on can be detected by a metal sensor, as in the first embodiment.

According to this embodiment, the accuracy of printing patterns and designs to the print object 73 can be increased as compared with the first embodiment.

### Third Embodiment

This embodiment takes the shape (the whole) of the print object 73 on the print-object mount surface 4 as image with the camera (imaging means) 13 moving with the printer head 9, using the similar system to that of the first embodiment.

The image is interposed on the image produced from the reference-pattern data set in the RAM of the memory 63, in almost the same way, on the basis of the detected inclination and distortion of the print object 73 on the print-object mount surface 4, thereby detecting the inclination and distortion (including partial distortion) of the print object 73 on the print bed.

After it is corrected on the basis of the determined print pattern and further corrected by the retouch section 19 as necessary, it is outputted from the output section 53 to the drive controller 54 and then the printer head 9 is driven to perform printing.

According to the embodiment, the course and wale of the print object 73 or a product 30 can be accurately recognized, so that also the zone where the knitted structure changes can be accurately recognized to allow fine retouch, thus significantly increasing the accuracy of the placement of parts of the print object and product and the printing accuracy for designs and patterns over the second embodiment.

Industrial Applicability

As set forth hereinabove, according to the present invention, a print object spread on a print bed is photographed with imaging means; pattern data obtained by the imaging means is compared with image data of a part of specified reference-pattern data inputted in advance in a memory of a controller which corresponds to the reference point to calculate the positional deviation between the print object spread on the bed and the specified image data stored in the memory, the specified image data stored in the memory is corrected by an image-display output section on the basis of the calculation to produce a print pattern agreed with the pattern data produced by the imaging means, and a printer head is driven on the basis of the print pattern; thus, the print object is printed by inkjet. Accordingly, there is no need to replace the print object on the printer bed from the beginning and to partially correct only large deviation as in the known art, thus offering the advantages of eliminating much time and labor required for correcting the print object to significantly increasing print efficiency.

The printed objects are subjected to post-processing including color-developing, cleaning, drying, finishing etc. after inkjet printing, so that the tension is released to contract the printed objects into a state of refined print objects. However, the contract amount by the post-process is taken into consideration when the specified image data stored in the memory is corrected by the image-display output section on the basis of the reference-point image data obtained by the imaging means. This eliminates the conventional problems of the distortion of designs and not providing specified designs and sizes, thus offering the advantage of producing high-quality products.

There is no need for tape masking, which has been required, offering the advantage of forming fine stripes with an inkjet printer including a display for displaying an image taken by the imaging means or data, a memory for storing specified image data, and a retouch section in which the image data taken by the imaging means is compared to the reference print pattern stored in the memory to designate a specific portion, and in which the print conditions are adopted singly in combination, such as the discharge amount of ink depending on the material and gage, the height of the printer head 3 depending on the entire or partial thickness of the knitted fabric and the evenness of the knitted fabric due to the texture, replacement of the printer head to change the kind of ink to suit the material and the roughness, and shading-off of the boundary.

1. An inkjet printer comprising a bed for mounting a print object in a spread state on the mount surface, a printer head movable in the X-axis direction and the Y-axis direction on the upper surface of the bed, imaging means moving with the printer head, and a controller for controlling the drive of the printer head, wherein the controller includes a memory for storing at least image data taken by the imaging means and specified reference-pattern data, an arithmetic processing section for calculating the deviation relative to the corresponding part of the reference-pattern data in the memory from the image data taken by the imaging means, and an output section for controlling the printer head on the basis of a print pattern produced from the calculation of the arithmetic processing section.

2. An inkjet printer according to claim 1, wherein the imaging means detects at least two or more points of the origin of the print object placed on the mount surface of the print bed and a reference point apart from the origin.

3. An inkjet printer according to claim 1, wherein the imaging means is constructed of a camera for photographing the outline and shape of the print object placed on the mount surface of the print bed.

4. An inkjet printer comprising a bed for mounting a print object in a spread state on the mount surface, a printer head movable in the X-axis direction and the Y-axis direction on the upper surface of the bed, imaging means moving with the printer head, and a controller for controlling the drive of the printer head, wherein the controller includes a memory for storing at least image data taken by the imaging means and specified reference-pattern data, and a retouch section producing a print pattern by designating a specific portion of at least one of the image data picked by the imaging means and displayed on a display and reference-pattern data stored in the memory, adopting a single or combination of print conditions: a change in discharge amount of ink depending on the material and gage, a change in height of the printer head depending on the entire or partial thickness of the knitted fabric and the roughness of the knitted fabric due to the knitted texture, replacement of the printer head for changing the kind of ink depending on the material and the roughness, and shading-off of the boundary.

5. An inkjet printing method comprising: photographing at least two or more points of a print object spread on the mount surface of a print bed with imaging means; comparing image data of the point taken by the imaging means to image data of a point of specified reference-pattern data inputted in advance in a memory of a controller which corresponds to the point to calculate the positional deviation between the print object spread on the bed and the specified reference-pattern data stored in the memory, correcting the specified reference-pattern data stored in the memory on the basis of the calculation to produce print-pattern data by an image synthesis section, and driving a printer head on the basis of the print-pattern data.
